(19) United States
(12) Patent Application Publication
(10) Pub. No.: US 2007/0269658 A1
(43) Pub. Date: Nov. 22, 2007

(54) SOLVENT-BORNE COATING COMPOSITIONS, RELATED METHODS AND SUBSTRATES

(76) Inventors: Constantine A. Kondos, Pittsburgh, PA (US); Ken W. Niederst, Allison Park, PA (US); Richard M. Nugent, Allison Park, PA (US)

Correspondence Address: PPG INDUSTRIES INC;INTELLECTUAL PROPERTY DEPT, ONE PPG PLACE, PITTSBURGH, PA, 15272, US

(21) Appl. No.: 11/424,264

(22) Filed: Jun. 15, 2006

Related U.S. Application Data
(60) Provisional application No. 60/798,448, filed on May 5, 2006.

(51) Int. Cl. B32B 27/38

(52) U.S. Cl. 428/413; 525/523; 428/423.1

(57) ABSTRACT

Disclosed are solvent-borne coating compositions. The solvent-borne coating compositions include (a) an amine-amide compound, and (b) a hydrophobic epoxy resin. The coating compositions can exhibit desirable humidity resistance properties as well as strong adhesive properties to certain polymeric substrates, such as polyamide substrates.

### CROSS-REFERENCE TO RELATED APPLICATIONS

This application claims the benefit of U.S. Provisional Patent Application Ser. No. 60/798,448, filed May 5, 2006, which is incorporated by reference herein in its entirety.

### FIELD OF THE INVENTION

The present invention relates to solvent-borne coating compositions. More particularly, the present invention is directed to solvent-borne coating compositions comprising: (a) an amine-amide compound, and (b) a hydrophobic epoxy resin. Such coating compositions can exhibit desirable humidity resistance properties and/or desirable adhesive properties to certain polymeric substrates, such as polyamide substrates.

### BACKGROUND OF THE INVENTION

Polymeric materials, such as polyamides, are used in many applications, such as in the manufacture of automobile parts and accessories, containers, consumer electronic devices, household appliances and other commercial items. Articles made from such materials are often coated with one or more coatings to decorate and/or protect a surface thereof from degradation when exposed to, for example, atmospheric weathering conditions, such as sunlight, moisture, heat and cold. To achieve longer lasting and more durable parts, it is desirable that such coatings adhere well to the surface of the article.

In many cases, adhesion promoting layers are used on polymeric surfaces, such as polyamide surfaces. These layers are often formed from chlorinated polyolefins, which, while often suitable, can provide some processing limitations. For example, while chlorinated polyolefins are soluble in aromatic solvents, THF, and chlorinated solvents, they are not readily soluble in solvents such as alcohols, ketones, or esters which are often preferred for use in coating compositions. Further, many chlorinated polyolefins typically have no curing or crosslinking sites and therefore must be used at high molecular weights to have a positive effect on coating strength.

Furthermore, in many applications, such as, for example, consumer electronics applications, it is important that coatings also exhibit resistance to humidity, i.e., the coating should remain adhered to the substrate even if exposed to hot and humid conditions.

As a result, it would be desirable to provide a coating composition capable of producing a coating that adheres to polymeric substrates, particularly polyamide substrates, while also exhibiting humidity resistance properties, such that the coating composition is suitable for use in, for example, consumer electronics applications.

### SUMMARY OF THE INVENTION

In certain respects, the present invention is directed to solvent-borne coating compositions comprising: (a) an amine-amide compound, and (b) a hydrophobic epoxy resin. These solvent-borne coating compositions are capable of producing a coating that adheres to a polyamide substrate and/or is humidity resistant.

In other respects, the present invention is directed to solvent-borne coating compositions comprising: (a) an amine-amide compound comprising the reaction product of (i) a polyamine having substantial aromatic content, and (ii) a polyfunctional compound comprising an acyl group that forms an amide group moiety by reaction with the polyamine; and (b) a hydrophobic epoxy resin formed from (i) a polyepoxide, and (ii) a functional-terminated diene-containing polymer.

In still other respects, the present invention is directed to polymeric substrates, such as polyamide substrates, at least partially coated with a coating that adheres to the substrate and is humidity resistant, and which is deposited from a solvent-based coating composition comprising: (a) an amine-amide compound, and (b) a hydrophobic epoxy resin.

The present invention is also directed to methods for improving the adhesion of a coating layer to a plastic substrate, such as a polyamide substrate. These methods comprise (a) applying to at least a portion of the substrate a solvent-borne coating composition comprising (i) an amine-amide compound, and (ii) a hydrophobic epoxy resin; (b) allowing the solvent-borne coating composition to cure to form a primer layer; and (c) applying a second coating composition over at least a portion of the primer layer to form the coating layer.

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. For example, and without limitation, this application refers to coating compositions that comprise “an epoxy resin”. Such references to “an epoxy resin” is meant to encompass coating compositions comprising one epoxy resin as well as coating compositions that comprise more than one epoxy resin, such as coating compositions that comprise two different epoxy resins. In addition, in this application, the use of “or” means “and/or” unless specifically stated otherwise, even though “and/or” may be explicitly used in certain instances.

As indicated, the present invention is directed to solvent-borne coating compositions. As used herein, the term “solvent-borne coating composition” refers to a composition that utilizes one or more volatile organic materials as the primary dispersing medium. Thus, the dispersing medium either consists exclusively of volatile organic material or comprises predominantly, i.e., >50%, volatile organic material in combination with another material, such as, for example, water.

In certain embodiments, however, the coating compositions of the present invention are substantially free of water, or, in some cases, completely free of water. As used herein, the term “substantially free” means that the material being discussed is present in the composition, if at all, as an incidental impurity. In other words, the material does not affect the properties of the composition. As used herein, the term “completely free” means that the material being discussed is not present in the composition at all. In certain embodiments, the amount of water present in the coating compositions of the present invention is less than 10 weight percent, such as less than 5 weight percent, or, in some cases, less than 2 weight percent, or, in yet other cases, less than 1 weight percent, with the weight percents being based on the total weight of the coating composition.

As indicated, the solvent-borne coating compositions of the present invention utilize one or more volatile organic materials as the primary dispersing medium. As used herein, the term “volatile organic material” refers to compounds that have at least one carbon atom and which are released from the composition during drying and/or curing thereof. Such materials are often included in coating compositions to reduce the viscosity of the composition sufficiently to enable forces available in simple coating techniques, such as spraying, to spread the coating to controllable, desired and uniform thicknesses. Also, such materials may assist in substrate wetting, resinous component compatibility, package stability and coalescence or film formation. Non-limiting examples of suitable volatile organic materials include aromatic hydrocarbons, such as toluene and xylene; ketones, such as methyl ethyl ketone and methyl isobutyl ketone; alcohols, such as isopropyl alcohol, normal-butyl alcohol and normal-propyl alcohol; monoethers of glycols, such as the monoethers of ethylene glycol and diethylene glycol; monoether glycol acetates, such as 2-ethoxyethyl acetate; as well as compatible mixtures thereof. In certain embodiments, the volatile organic material is present in the coating compositions of the present invention in amounts up to 99 percent by weight, such as 50 to 95 percent by weight, based on the total weight of the coating composition.

As previously indicated, in certain embodiments, the present invention is directed to solvent-based coating compositions comprising an amine-amide compound. As used herein, the term “amine-amide compound” refers to a compound having a molecular structure comprising both an amine group, i.e., a group having the general formula of R₃₋ₓNHₓ, wherein R is an organic residue and 0<x<3, and an amide group, i.e., a group having the general formula of (CO)NR₂, wherein R is an organic residue. As used herein, the term “organic residue” refers to an organic group bound to a fundamental structure. In certain embodiments, the amine-amide compounds used in the compositions of the present invention comprise the reaction product of (i) a polyamine, and (ii) a polyfunctional compound comprising an acyl group that forms an amide group moiety by reaction with the polyamine to form an oligomer.

As used herein, the term “polyamine” refers to compounds having two or more amine groups, such as, for example, diamines, triamines, and tetraamines. Suitable polyamines for use in the present invention include, for example, primary or secondary polyamines in which the radicals attached to the nitrogen atoms can be saturated or unsaturated, aliphatic, alicyclic, aromatic, aromatic-substituted-aliphatic, aliphatic-substituted-aromatic, and/or heterocyclic. Nonlimiting examples of suitable aliphatic and alicyclic diamines include 1,2-ethylene diamine, 1,2-propylene diamine, 1,8-octane diamine, isophorone diamine, propane-2,2-cyclohexyl amine, and the like. Nonlimiting examples of suitable aromatic diamines include phenylene diamines and toluene diamines, for example o-phenylene diamine and p-tolylene diamine. These and other suitable polyamines are described in U.S. Pat. No. 4,046,729 at column 6, line 61 to column 7, line 26, the cited portion of which being incorporated herein by reference.

In certain embodiments, the polyamine used in the preparation of the coating compositions of the present invention is characterized by having substantial aromatic content, i.e., at least 50 percent, in some cases at least 70 percent, of the carbon atoms are in aromatic rings, including fused aromatic rings (i.e., phenylene groups and/or naphthalene groups). Such polyamines are described in U.S. Pat. No. 5,637,365 at col. 6, line 38 to col. 7, line 40, the cited portion of which being incorporated herein by reference.

As previously indicated, the amine-amide compound present in certain embodiments of the coating compositions of the present invention is the reaction product of a polyfunctional compound comprising an acyl group that forms an amide group moiety by reaction with the polyamine to form an oligomer. As used herein, the term “acyl group” refers to a group according to the general formula —COR, wherein R is an organic residue and there is a double bond between the carbon and the oxygen. Examples of such materials include, but are not limited to, carboxylic acids, such as (meth)acrylic acid and polycarboxylic acids, such as aliphatic, cycloaliphatic, and aromatic polycarboxylic acids, including, but not limited to, phthalic acid, isophthalic acid, terephthalic acid, oxalic acid, malonic acid, succinic acid, glutaric acid, adipic acid, pimelic acid, suberic acid, 1,4-napthalenedicarboxylic acid, 2,3-napthalenedicarboxylic acid, 2,6-napthalenedicarboxylic acid, mixtures thereof, including derivatives thereof, such as ester, amide, acid anhydride and acid chloride. In certain embodiments, a (meth)acrylic acid and/or a derivative thereof, such as methyl(meth)acrylate, is used. As used herein, the terms “(meth)acrylic,” “(meth)acrylate,” and the like, are meant to include both acrylic and methacrylic.

Regarding the reaction of the polyamine, such as a polyamine having substantial aromatic content, as described above, and the polyfunctional compound comprising an acyl group, when carboxylic acid, an ester thereof, or an amide thereof, is used as the polyfunctional compound, the reaction may be performed by mixing the polyamine and the polyfunctional compound at a temperature of 0 to 100° C. and then conducting an amide group formation reaction due to dehydration, dealcoholization and deamination at a temperature of 100 to 300° C., such as 130 to 250° C. In the amide group formation reaction, a reduced pressure treatment of the reactor interior may be performed at the final stage of the reaction. Further, dilution may be performed with a non-reactive solvent. A catalyst, such as sulfite, may also be added as a dehydrating agent or a dealcoholizing agent. The Examples herein also illustrate suitable methods and conditions for conducting such a reaction.

In certain embodiments, the reaction ratio of the polyfunctional compound and the polyamine is in the range of a molar ratio of 0.3 to 0.95:1.

In certain embodiments, the amine-amide compound present in the compositions of the present invention comprises the reaction product of polyamine (i) and polyfunctional compound (ii), as described above, and (iii) a monocarboxylic acid having 1 to 8 carbon atoms and/or a derivative thereof. Non-limiting examples of such materials are formic acid, acetic acid, propionic acid, butyric acid, lactic acid, glycolic acid, benzoic acid and/or derivatives thereof, e.g., ester, amide, acid anhydride and acid chloride.

In certain embodiments, the compositions of the present invention are substantially free or, in some cases, completely free, of any aliphatic amine compound manufactured using mainly a fatty acid or higher alcohol as a raw material, i.e., those comprising eight or more carbon atoms.

As previously indicated, the solvent-borne coating compositions of the present invention also comprise a hydrophobic epoxy resin. As used herein, the term “hydrophobic epoxy resin” refers to an epoxy group containing resin that essentially is not compatible with, does not have an affinity for, and/or is not capable of dissolving in water using conventional mixing means. That is, upon mixing a sample of the hydrophobic epoxy resin with an organic component and water, a majority of the epoxy resin is in the organic phase and a separate aqueous phase is observed. See Hawley's Condensed Chemical Dictionary, (12th Ed. 1993) at page 618.

In certain embodiments, the hydrophobic epoxy resin included in the coating compositions of the present invention comprises an elastomer-modified epoxy formed from a polyepoxide and a functionally-terminated diene-containing polymer. As used herein, the term “polyepoxide” refers to any epoxide group-containing compound having two or more epoxide groups per molecule. As used herein, the term “formed from” denotes open, e.g., “comprising,” claim language. As such, it is intended that a composition or substance “formed from” a list of recited components be a composition or substance formed from at least the recited components, and can further comprise other, non-recited components, during formation thereof. Additionally, as used herein, the term “polymer” is meant to encompass oligomers, and includes without limitation both homopolymers and copolymers.

In certain embodiments, the elastomer-modified epoxy utilized in certain embodiments of the present invention is prepared by reacting from 5 to 35, such as 10 to 30, or, in some cases 15 to 25, percent by weight of a functionally-terminated diene-containing polymer with from 65 to 95, such as 70 to 90, or, in some cases, 75 to 85, percent by weight of a polyepoxide, based on the total weight of reactants. The functional groups of the diene-containing polymer should be reactive with the epoxide groups of the polyepoxide and may be, for example, carboxyl, phenol, hydroxyl, amino and/or mercaptan groups.

In certain embodiments, the functionally-terminated diene-containing polymer is of the general formula: X-B-X, wherein X is a functional group, such as any of those listed immediately above, and B is a polymer backbone polymerized from a diene having from 4 to 10 carbon atoms (C₄ to C₁₀ diene); a C₄ to C₁₀ diene and a vinyl aromatic monomer (e.g., styrene, an alkyl-substituted styrene, a halo-substituted styrene and the like); a C₄ to C₁₀ diene and a vinyl nitrile (e.g., acrylonitrile or methacrylonitrile); a C₄ to C₁₀ diene, a vinyl nitrile and a vinyl aromatic monomer; and/or a C₄ to C₁₀ diene, a vinyl nitrile and an acrylate of the formula CH₂═CR—COOR¹, wherein R is hydrogen or an alkyl radical containing from one to four carbon atoms (C₁ to C₄ alkyl) and R¹ is hydrogen or an alkyl radical containing from one to ten carbon atoms (C₁ to C₁₀ alkyl). In certain embodiments, the functionally-terminated diene-containing polymer is carboxyl-terminated, such as carboxyl-terminated polybutadiene, carboxyl-terminated polyisoprene, carboxyl-terminated poly(butadiene-acrylonitrile), carboxyl-terminated poly(butadiene-acrylonitrile-acrylic acid), carboxyl-terminated poly(butadiene-styrene-acrylonitrile) and carboxyl-terminated poly(butadiene-styrene).

In certain embodiments, the functionally-terminated diene-containing polymer comprises a carboxyl-terminated poly(butadiene-acrylonitrile), or carboxyl-terminated butadiene-acrylonitrile copolymer, that includes between 15 and 40, such as 18 to 35, percent by weight acrylonitrile and between 70 and 100, such as 74 to 90, percent by weight butadiene. Such carboxyl-terminated butadiene-acrylonitrile copolymers are functionally-terminated to react with the polyepoxide. Other functional groups may also be present. While the terminal carboxyl functionality of the diene-containing polymer, such as, the butadiene-acrylonitrile copolymer, has a theoretical maximum of 2.0, the functionality is often from 1.1 to 2.0, such as 1.8 to 2.0. In certain embodiments, the carboxyl-terminated butadiene-acrylonitrile copolymer utilized in certain embodiments of the present invention has a number average molecular weight from 3,000 to 6,000, such as 3,200 to 4,000. Functionally-terminated diene-containing polymers, which are suitable for use in the present invention, are commercially available from the B. F. Goodrich company under the trademark HYCAR, such as Hycar® 1300X31, 1300X21, 1300X8, 1300X13, 1300X9, CTBN X8 and 1300X18.

In certain embodiments, the polyepoxide from which the elastomer-modified epoxy is derived is a polymer having a 1,2-epoxy equivalency greater than one, such as two or more. The polyepoxide may be, for example, saturated or unsaturated, aliphatic, cycloaliphatic, aromatic or heterocyclic. In certain embodiments, the polyepoxide is a polyglycidyl ether of a polyhydric phenol. Such polyepoxides can be produced by reacting an epihalohydrin (such as epichlorohydrin or epibromohydrin) with a polyhydric phenol in the presence of an alkali. Suitable examples of polyhydric phenols include: 2,2-bis(4-hydroxyphenyl)propane (Bisphenol A); 2,2-bis(4-hydroxy-tert butylphenyl)propane; 1,1-bis(4-hydroxyphenyl)ethane; 1,1-bis(4-hydroxyphenyl)isobutane; 2,2-bis(4-hydroxytertiarybutylphenyl)propane; bis(2-hydroxynaphthyl)methane; 1,5-dihydroxynaphthalene; 1,1-bis(4-hydroxy-3-alkylphenyl)ethane and the like.

Another useful class of polyepoxide is produced from novolac resins or similar polyhydroxyphenol resins. Also suitable are polyglycidyl ethers of glycol or polyglycols. The polyepoxide resin may also be a polyglycidyl ester of polycarboxylic acids.

In certain embodiments, the reaction of the functionally-terminated diene-containing polymer with the polyepoxide is conducted at temperatures from about 80 to 160° C., such as 120 to 140° C., for from 0.5 to 5 hours or generally until the reaction mixture has a measured acid number of 0.5 or less. Generally, shorter reaction times are required at higher temperatures. A catalyst for the epoxy-carboxyl reaction may be added to the reaction mixture in amounts of, for example, 0.01 to 1.0 percent by weight, based on total weight of the reactants. In certain embodiments, the catalyst is a tertiary amine, such as tributylamine, a tertiary phosphate, such as triphenylphosphate, a quaternary phosphonium salt, such as ethyltriphenylphosphonium iodide and the like, and/or a metal salt, such as stannous octate and the like. In certain embodiments, the reaction product of the carboxyl-terminated diene-containing polymer and the polyepoxide has an epoxy equivalent weight (EEW) of at least 3,500, an acid value of less than 0.5, such as 0 to 0.2, a softening point of 70 to 100° C., and/or a molecular weight of at least 7,000. In certain embodiments, the elastomer-modified epoxy is prepared by reacting an epoxy resin such as a low molecular weight diglycidyl ether of bisphenol A, e.g., EPON 828, with a polyhydric phenol such as, e.g., bisphenol A, and the carboxyl-terminated diene-containing polymer. As used herein, the term “molecular weight” refers to number average molecular weight as determined by gel permeation chromatography using polystyrene standards.

In certain embodiments of the solvent-borne coating compositions of the present invention, the weight ratio of the amine-amide compound to the hydrophobic epoxy resin present in the coating composition is no more than 30:70.

In certain embodiments, the solvent-borne coating compositions of the present invention have an amine nitrogen content of less than 7 percent, such as 6 percent or less. As a result, certain embodiments of the coating compositions of the present invention are not suitable for use as a gas barrier coating, and, therefore, these embodiments of the present invention should be distinguished from such coatings. As will be appreciated by those skilled in the art, it has been found that generally as the amount of amine nitrogen content in a coating material increases, the gas permeability decreases. See, e.g., U.S. Pat. No. 5,637,365 at col. 5, lines 32 to 61, the cited portion of which being incorporated herein by reference.

The solvent-borne coating compositions of the present invention may include other additives, e.g., catalysts, pigments, fillers, light stabilizers, flow control agents, anti-popping agents, and antioxidants. If desired, other resinous materials can be utilized in conjunction with the aforementioned resins. Certain embodiments of the coating compositions of the present invention include surface active agents include, such as any of the well known anionic, cationic or nonionic surfactants or dispersing agents.

In certain embodiments, the solvent-borne coating compositions of the present invention comprise a pigment, which, in certain embodiments, is present in amounts from 1 to 50 percent by weight, based on total weight of the composition. Suitable pigments include, e.g., basic lead silica chromate, titanium dioxide, barium sulfate, ultramarine blue, phthalocyanine blue, phthalocyanine green, carbon black, black iron oxide, chromium green oxide, ferrite yellow, or quindo red.

In certain embodiments, the solvent-borne coating compositions of the present invention can further include inorganic and/or inorganic-organic particles, for example, silica, alumina, including treated alumina (e.g. silica-treated alumina known as alpha aluminum oxide), silicon carbide, diamond dust, cubic boron nitride, and boron carbide. In certain embodiments, such particles comprise inorganic particles that have an average particle size ranging from 1 to 10 microns, or from 1 to 5 microns prior to incorporation into the coating composition.

In certain embodiments, such inorganic particles can have an average particle size ranging from 1 to less than 1000 nanometers, such as from 1 to 100 nanometers, or, in some cases, from 5 to 50 nanometers, or, in yet other cases, 5 to 25 nanometers, prior to incorporation into the composition. These materials may constitute, in certain embodiments of the present invention, up to 30 percent by weight, such as 0.05 to 5 percent by weight, or, in some cases, 0.1 to 1 percent by weight, or, in yet other cases, 0.1 to 0.5 percent by weight, based on the total weight of the coating composition.

In certain embodiments, the solvent-borne coating compositions of the present invention comprise a catalyst to increase the reaction rate of the polyamine and the hydrophobic epoxy resin. Suitable catalysts are quaternary ammonium salts, quaternary phosphonium salts, phosphines, imidazoles and metal salts. Examples include tetrabutylammonium chloride, tetrabutylammonium bromide or tetrabutylammonium iodide, ethyltriphenyl phosphonium acetate, triphenylphosphine, 2-methyl imidazole and dibutyltin dilaurate. The catalyst, when used, is often present in the composition in amounts of between 0 and 5 weight percent, such as 0.2 to 2 percent by weight based on total weight of the coating composition.

In certain embodiments, the solids content of the coating compositions of the present invention ranges from 5 to 25 percent by weight, such as 5 to 15 percent by weight, based on the total weight of the coating composition.

Suitable methods for making the coating compositions of the present invention are set forth in the Examples. In certain embodiments, the coating compositions of the present invention are embodied as a two-component composition, wherein, prior to application of the coating composition to a substrate, a first component that includes the polyamine, and a second component, that includes the hydrophobic epoxy resin, are mixed together. In certain embodiments, the coating compositions of the present invention have a pot life of up to 8 hours, such as up to 4 hours. As used herein the term “pot life” refers to the length of time that the coating composition remains sufficiently flowable to be coatable. In other embodiments, however, the coating compositions of the present invention are embodied as a single component composition, such as is illustrated in the Examples.

The coating compositions of the present invention can be applied to various substrates including wood, metals, glass, paper, masonry surfaces, foam, and plastic, including elastomeric substrates, among others. In some cases, the coating compositions of the present invention are particularly suitable for application to plastic substrates. As used herein, the term “plastic substrate” is intended to include any thermoplastic or thermosetting synthetic material used in injection or reaction molding, sheet molding or other similar processes whereby parts are formed, such as, for example, acrylonitrile butadiene styrene (“ABS”), polycarbonate, thermoplastic elastomer, polyurethane, polyamide, and thermoplastic polyurethane, among others. As a result, the present invention is also directed to substrates at least partially coated with a coating deposited from a coating composition of the present invention. The compositions can be applied by conventional means including brushing, dipping, flow coating, spraying and the like. The usual spray techniques and equipment for air spraying and either manual or automatic methods can be used.

After application of the coating composition of the present invention to the substrate, the composition is normally allowed to coalesce to form a substantially continuous film on the substrate. Often, the film thickness will be 0.01 to 20 mils (about 0.25 to 508 microns), such as 0.01 to 5 mils (0.25 to 127 microns), or, in some cases, 0.1 to 2 mils (2.54 to 50.8 microns). In certain embodiments, however, the solvent-borne coating compositions of the present invention are used as a thin film primer, wherein the compositions is applied such that a dry film thickness of no more than 0.5 mils (12.7 microns), such as 0.2 to 0.4 mils (5.08 to 10.16 microns) is obtained. The film is often formed on the surface of the substrate by driving volatile material out of the film by heating or by an air drying period. In some cases, the heating will only be for a short period of time, sufficient to ensure that any subsequently applied coatings can be applied to the film without dissolving the composition. Suitable drying conditions will depend on the particular composition and substrate, but, in general, a drying time of from about 1 to 5 minutes at a temperature of 68° F. to 250° F. (20° C. to 121° C.) will be adequate. More than one coat of the coating composition may be applied. Between coats, the previously applied coat may be flashed, that is, exposed to ambient conditions for 1 to 20 minutes.

Certain solvent-borne coating compositions of the present invention have been found to be particularly useful for application, and adherence, to polyamide substrates. Such substrate materials are often used in consumer electronics applications, such as cellular telephones. As a result, the solvent-borne coating compositions of the present invention often are particularly suitable for direct application to such substrates. By “direct” application it is meant application to a bare, uncoated substrate.

As used herein, the term “polyamide substrate” refers to a substrate constructed from a polymer that includes mers of the formula:

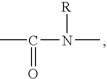

wherein R is hydrogen or an alkyl group. The polyamide may be any of a large class of polyamides based on aliphatic, cycloaliphatic, or aromatic groups in the chain. They may be formally represented by the products of condensation of a dibasic amine with a dibasic acid, such as poly(hexamethylene adipamide), by the product of self-condensation of an amino acid, such as omega-aminoundecanoic acid, or by the product of a ring-opening reaction of a cyclic lactam, such as caprolactam, lauryllactam, or pyrrolidone. They may contain one or more alkylene, arylene, or aralkylene repeating units. The polyamide may be crystalline or amorphous. In certain embodiments, the polyamide substrate comprises a crystalline polyamide of alkylene repeating units having from 4 to 12 carbon atoms, such as poly(caprolactam), known as nylon 6, poly(lauryllactam), known as nylon 12, poly(omega-aminoundecanoic acid), known as nylon 11, poly(hexamethylene adipamide), known as nylon 6.6, poly(hexamethylene sebacamide), known as nylon 6.10, and/or an alkylene/arylene copolyamide, such as that made from meta-xylylene diamine and adipic acid (nylon MXD6). Amorphous polyamides, such as those derived from isophoronediamine or trimethylcyclohexanediamine, may also be utilized. Blends of polyamides may also be utilized. In certain embodiments, the substrate comprises a polyamide material reinforced with glass fibers and/or mineral fibers, such as carbon fibers. Such materials are commercially available from Solvay Advanced Polymers under the IXEF® name and, include, for example, the IXEF 1000, 1500, 1600, 2000, 2500, 3000 and 5000 series products.

As indicated, the solvent-borne coating compositions of the present invention, in certain embodiments, are capable of producing a coating that adheres to a polyamide substrate. As used herein, the phrase “adheres to a polyamide substrate” means that at least 85% of the coating adheres to the substrate when measured using a crosshatch adhesion test conducted 1 day after the coating is applied and cured and 7 days after the coating is applied and cured. The crosshatch adhesion test is conducted according to ASTM Test Method D 3359 Method B using a multi-blade cutter (commercially available from Paul N. Gardner Co., Inc.), wherein the coated polyamide substrate is scribed at least twice (at 90° angle), making sure the blades cut through all coating layers into the substrate, and adhesion is measured using 610 tape (3M Corp.) and Nichiban L-24 tape (one pull of 610 tape and three pulls Nichiban L-24 tape at 90°).

Moreover, in certain embodiments, the coating compositions of the present invention are capable of producing a coating that is humidity resistant. As used herein, when it is stated that a coating is “humidity resistant” it means that at least 85% of the coating adheres to a substrate when measured using a crosshatch adhesion test, as described above, conducted following exposure of the coated substrate to elevated temperature (˜65° C.) and humidity (˜90%) for 48 hours.

As a result, the present invention is also directed to solvent-borne coating compositions, as previously described, wherein the composition, when applied to at least a portion of a polyamide substrate and cured, produces a coating that adheres to the polyamide substrate and/or is humidity resistant.

The coating compositions of the present invention may be used as a single coating, a clear top coating, a base coating in a two-layered system, or one or more layers of a multi-layered system including a clear top coating composition, colorant layer and base coating composition, or as a primer layer.

As previously indicated, in certain embodiments, the solvent-borne coating compositions of the present invention are used as a primer layer on plastic substrates, such as polyamide substrates. In these embodiments, the coating compositions of the present invention may be used as part of a multi-component composite coating, such as a “color-plus-clear” coating system, which includes at least one pigmented or colored base coat and at least one clear topcoat. As a result, the present invention is also directed to multi-component composite coatings, wherein at least one coating layer is deposited from a composition comprising a coating composition of the present invention.

In such embodiments, the coating composition of the base coat and/or clear topcoat in the multi-components composite coating may comprise any composition useful in coatings applications, such as those typically used in automotive OEM applications, automotive refinish applications, industrial coating applications, architectural coating applications, electrocoating applications, powder coating applications, coil coating applications, and aerospace coating applications, among others. The coating composition of the base coat and/or clear topcoat typically comprises a resinous binder. Particularly useful resinous binders include, for example, acrylic polymers, polyesters, including alkyds, and polyurethanes, among others.

In certain embodiments, the present invention is directed to methods for improving the adhesion of a coating layer to a plastic substrate, such as a polyamide substrate. These methods comprise (a) applying to at least a portion of the substrate a solvent-borne coating composition comprising (i) an amine-amide compound, and (ii) a hydrophobic epoxy resin; (b) allowing the solvent-borne coating composition to cure to form a primer layer; and (c) applying a second coating composition over at least a portion of the primer layer, to form the coating layer.

Illustrating the invention are the following examples, which, however, are not to be considered as limiting the invention to their details. Unless otherwise indicated, all parts and percentages in the following examples, as well as throughout the specification, are by weight.

### EXAMPLE 1

To a flask under nitrogen blanket was placed, 345.2 grams (0.088 moles) Hycar® CTBN X8, from B. F. Goodrich company, 60.5 grams (0.162 moles) EPON 828, 0.8 grams ethyltriphenylphosphonium iodide, and 218.9 grams m-pyrol. The mixture was heated to 80° C. and held until the epoxy equivalent weight was greater than 3901, approximately 1 hour. Final epoxy equivalent weight of the 65.2% total solids product was 4945.

### EXAMPLE 2

A flask under nitrogen blanket containing 231.2 grams (1.7 moles) meta-xylylene diamine (“MXDA”) was heated to 60° C. with stirring. The temperature was maintained at 60° C. while 136.0 grams (1.58 moles) methyl acrylate was added. Following the addition, the temperature was increased to 120° C. and held for 1 hour. A distillation was then performed by increasing the temperature to 180° C. and holding for two hours or until the theoretical amount of methanol distillate was obtained. After cooling to 140° C., 170.4 grams of ethanol was added slowly to yield the product at 67.9% total solids and 4.10 mmol base/gram.

### EXAMPLE 3

Into a flask under nitrogen blanket was placed 200.5 grams (0.05 moles) of the product of Example 2 and 233.8 grams Dowanol PM. The mixture was heated to 90° C. and to this was added over a period of two hours a mixture of 207.2 grams (0.028 moles) of the product of Example 1 and 241.8 grams Dowanol PM while maintaining a temperature of 90° C. The resultant mixture was then held at this temperature for 40 minutes, until the epoxy equivalent weight was greater than 50,000. Final product was 0.93 mmol base/gram at 30.9% total solids.

### EXAMPLE 4

In a 1 pint container, the following materials were added in sequence under blade agitation with an air motor. Firstly, 109.4 grams of n-butanol was added to the pint container. Secondly, 44.4 grams of the product of Example 1 was blended into the n-butanol. Next, 73.0 grams of xylene was blended into this mixture followed by 12.68 grams of the product of Example 2. 72.96 grams on n-propanol was added to this mixture and finally 87.6 grams of toluene was added to this mixture. The mixture was then blended for an additional 2 minutes. The theoretical percent solid for this composition was 9.12% solids. The composition was then applied as described in Example 5, 15 to 30 minutes after equilibrating.

### EXAMPLE 5

The Nylon panels tested were IXEF 1622 and IXEF1022 available from Solvay Advanced Polymers, Oudenaarde, Belgium. All panels were wiped with isopropanol and allowed to dry thoroughly. The composition of Example 4 and a commercially available adhesion promoter, SX 1050, a chlorinated polyolefin containing adhesion promoter commercially available from PPG Industries, Inc. were hand spray applied to each substrate, with a line pressure of 40 psi, to a dry film build of ˜0.20 mil, and were thoroughly air dried. Two coats of a basecoat and clearcoat were then applied to each substrate, also by hand spray application, with a line pressure of 50 psi. There was a 60 second basecoat flash between basecoat applications, a 90 second flash between basecoat and clearcoat application, and a 60 second flash between clearcoat applications.

The basecoat formulations used were a commercial black basecoat, XPB21920VS, and a commercial grey basecoat, XPB22392VS, both commercially available from PPG Industries, Inc. A 2-component clearcoat system, XPC60021, was used as was a UV clear topcoat, XPC70041, both of which are commercially available from PPG Industries, Inc. These coatings were applied at standard film builds of ˜0.5 mil for XPB21920VS, ˜0.75 mil for XPB22392VS, ˜1.2 mils for XPC60021, and ˜1.0 mil for XPC70041. After the clearcoat application, the wet coatings were allowed to flash for ˜10 minutes. XPC60021 was cured for 30 minutes at 170° F. and XPC70041 was cured under UV light at between ˜0.50 to 0.60 mJ/cm² of UV light intensity.

### EXAMPLE 6

In a 1 pint container the following materials were added in sequence under blade agitation with an air motor. Firstly, 100.0 grams of n-butanol was added to the pint container. Secondly, 200.0 grams of xylene was blended to the n-butanol. Lastly, 120.0 grams of the product of Example 3 was slowly added into the pint container. The mixture was then blended for an additional 2 minutes. The theoretical percent solid for this composition was 8.57% solids. The composition was then applied as described in Example 7, 15 to 30 minutes after equilibrating.

### EXAMPLE 7

The Nylon panels tested were IXEF 1622 and IXEF1022 available from Solvay Advanced Polymers, Oudenaarde, Belgium and LV-5H and GV-5H available from EMS-CHEMIE AG, Business Unit EMS-GRIVORY Performance Polymers. All panels were wiped with isopropanol and allowed to dry thoroughly. The composition of Example 6 and a commercially available adhesion promoter, SX 1050, a chlorinated polyolefin containing adhesion promoter commercially available from PPG Industries, Inc. were hand spray applied to each substrate, with a line pressure of 40 psi and were thoroughly air dried. Two coats of a basecoat and clearcoat were then applied to each substrate, also by hand spray application, with a line pressure of 50 psi. There was a 60 second basecoat flash between basecoat applications, a 90 second flash between basecoat and clearcoat application, and a 60 second flash between clearcoat applications.

The basecoat formulations used were a commercial black basecoat, XPB21920VS, and a commercial grey basecoat, XPB22392VS, both commercially available from PPG Industries, Inc. A 2-component clearcoat system, XPC60021, was used which is commercially available from PPG Industries, Inc. These coatings were applied over at standard film builds of ˜0.5 mil for XPB21920VS, ˜0.75 mil for XPB22392VS, and ˜1.2 mils for XPC60021. After the clearcoat application, the wet coatings were allowed to flash for ˜10 minutes. XPC60021, was cured for 30 minutes at 170° F. and XPC70041.

### EXAMPLES 8 AND 9

### Test Substrates

All adhesion testing was conducted using the ASTM D3359 Method B using one pull on 3M 610 tape and three additional pulls of LP-24 Nichiban Tape. Eleven cuts were made in each direction creating one mm squares. The results are reported as 5B—perfect adhesion, 4B—small flakes detach, less than 5% of the area is affected, no full square is lost, 3B—5% to 15% delamination, 2B—15% to 35% delamination, 1B—35% to 65% delamination, and 0B—>65% delamination. Visual inspection was done after the fourth tape pull. Initial adhesion was conducted randomly on the panels. Adhesion testing after humidity was conducted randomly on the panels. Humidity testing was conducted for 48 hours at 65° C. and 90% relative humidity. Adhesion after the humidity cycle was conducted after approximately 1 hour at ambient conditions. Results are set forth in Tables I and II.

TABLE I

| | | | | | | | | | Adhesion | 3 days |
|---|---|---|---|---|---|---|---|---|---|---|
| | | Primer Film | | | IXEF | 1 day | 7 day | | after | after |
| Example | Primer | Build | Basecoat | Clearcoat | Substrate | Adhesion | Adhesion | | humidity | humidity |
| 8A | SX1050 | 0.15 mils | XPB21920VS | XPC60021 | 1022 | 5B+ | 5B | 5B | 5B | 5B |
| | SX1050 | 0.15 mils | XPB21920VS | XPC60021 | 1622 | 4B | 4B | 4B | 2B | 3B |
| 8B | SX1050 | 0.15 mils | XPB22392VS | XPC60021 | 1022 | 5B+ | 5B | 5B | 4B | 5B |
| | SX1050 | 0.15 mils | XPB22392VS | XPC60021 | 1622 | 5B+ | 5B | 5B | 3B | 4B |
| 8C | SX1050 | 0.15 mils | XPB21920VS | XPC70041 | 1022 | 4B | 5B | 5B | 4B | 4B |
| | SX1050 | 0.15 mils | XPB21920VS | XPC70041 | 1622 | 4B | 4B | 5B | 4B | 4B |
| 8D | SX1050 | 0.15 mils | XPB22392VS | XPC70041 | 1022 | 4B | 5B | 5B | 4B | 4B |
| | SX1050 | 0.15 mils | XPB22392VS | XPC70041 | 1622 | 3B | 5B | 5B | 3B | 3B |
| 8E | Example #4 | 0.20 mils | XPB21920VS | XPC60021 | 1022 | 5B+ | 5B | 5B | 4B | 4B |
| | Example #4 | 0.20 mils | XPB21920VS | XPC60021 | 1622 | 5B+ | 5B | 5B | 5B | 5B |
| 8F | Example #4 | 0.20 mils | XPB22392VS | XPC60021 | 1022 | 2B | 5B | 4B | 2B | 3B |
| | Example #4 | 0.20 mils | XPB22392VS | XPC60021 | 1622 | 5B+ | 3B | 2B | 3B | 4B |
| 8G | Example #4 | 0.20 mils | XPB21920VS | XPC70041 | 1022 | 5B | 5B | 5B | 4B | 5B |
| | Example #4 | 0.20 mils | XPB21920VS | XPC70041 | 1622 | 5B | 5B | 5B | 4B | 4B |
| 8H | Example #4 | 0.20 mils | XPB22392VS | XPC70041 | 1022 | 5B | 5B | 5B | 4B | 4B |
| | Example #4 | 0.20 mils | XPB22392VS | XPC70041 | 1622 | 5B | 5B | 5B | 4B | 4B |

TABLE II

| | | | | | | | | Adhesion |
|---|---|---|---|---|---|---|---|---|
| | | Primer Film | | | | 1 day | 7 day | after |
| Example | Primer | Build | Basecoat | Clearcoat | Substrate | Adhesion | Adhesion | humidity |
| 9A | SX1050 | 0.3 mils | XPB21920VS | XPC60021 | IXEF1022 | 5B | 5B | 4B |
| | SX1050 | 0.3 mils | XPB21920VS | XPC60021 | IXEF1622 | 5B | 5B | 4B |
| | SX1050 | 0.3 mils | XPB21920VS | XPC60021 | LV-5H | 5B | 5B | 5B |
| | SX1050 | 0.3 mils | XPB21920VS | XPC60021 | GV-5H | 5B | 5B | 4B |
| 9B | SX1050 | 0.3 mils | XPB22392VS | XPC60021 | IXEF1022 | 5B | 5B | 4B |
| | SX1050 | 0.3 mils | XPB22392VS | XPC60021 | IXEF1622 | 5B | 5B | 3B |
| | SX1050 | 0.3 mils | XPB22392VS | XPC60021 | LV-5H | 5B | 5B | 5B |
| | SX1050 | 0.3 mils | XPB22932VS | XPC60021 | GV-5H | 5B | 5B | 5B |
| 9C | Example #6 | 0.45 mils | XPB21920VS | XPC60021 | IXEF1022 | 4B | 4B | 2B |
| | Example #6 | 0.45 mils | XPB21920VS | XPC60021 | IXEF1622 | 4B | 5B | 3B |
| | Example #6 | 0.45 mils | XPB21920VS | XPC60021 | LV-5H | 2B | 2B | 3B |
| | Example #6 | 0.45 mils | XPB21920VS | XPC60021 | GV-5H | 5B | 5B | 4B |
| 9D | Example #6 | 0.45 mils | XPB22392VS | XPC60021 | IXEF1022 | 5B | 5B | 4B |
| | Example #6 | 0.45 mils | XPB22392VS | XPC60021 | IXEF1622 | 5B | 5B | 4B |
| | Example #6 | 0.45 mils | XPB22392VS | XPC60021 | LV-5H | 5B | 5B | 4B |
| | Example #6 | 0.45 mils | XPB22392VS | XPC60021 | GV-5H | 5B | 5B | 4B |

Whereas particular embodiments of this invention have been described above for purposes of illustration, it will be evident to those skilled in the art that numerous variations of the details of the present invention may be made without departing from the invention as defined in the appended claims.

We claim:

1. A solvent-borne coating composition comprising:
(a) an amine-amide compound, and
(b) a hydrophobic epoxy resin,
wherein the solvent-borne coating composition is capable of producing a coating that adheres to a polyamide substrate.

2. The solvent-borne coating composition of claim 1, wherein the composition is substantially free of water.

3. The solvent-borne coating composition of claim 1, wherein the amine-amide compound comprises the reaction product of:
(i) a polyamine, and
(ii) a polyfunctional compound comprising an acyl group that forms an amide group moiety by reaction with the polyamine.

4. The solvent-borne coating composition of claim 3, wherein at least 50 percent of the carbon atoms in the polyamine are in aromatic rings.

5. The solvent-borne coating composition of claim 4, wherein the polyamine comprises xylylenediamine.

6. The solvent-borne coating composition of claim 3, wherein the polyfunctional compound comprises methyl(meth)acrylate.

7. The solvent-borne coating composition of claim 3, wherein the reaction ratio of the polyfunctional compound to the polyamine is a molar ratio of 0.3 to 0.95:1.

8. The solvent-borne coating composition of claim 1, wherein the composition is substantially free of any aliphatic amine compound manufactured using a fatty acid or higher alcohol as a raw material.

9. The solvent-borne coating composition of claim 1, wherein the hydrophobic epoxy resin has an epoxy equivalent weight of at least 3,500.

10. The solvent-borne coating composition of claim 1, wherein the hydrophobic epoxy resin comprises an elastomer-modified epoxy formed from a polyepoxide and a functionally-terminated diene-containing polymer.

11. The solvent-borne coating composition of claim 10, wherein the functionally-terminated diene-containing polymer comprises carboxyl functional groups.

12. The solvent-borne coating composition of claim 11, wherein the functionally-terminated diene-containing polymer comprises a polymer backbone polymerized from a diene having from 4 to 10 carbon atoms and a vinyl nitrile.

13. The solvent-borne coating composition of claim 1, wherein the hydrophobic epoxy resin has a molecular weight of 7,000.

14. The solvent-borne coating composition of claim 1, wherein the weight ratio of the amine-amide compound and the hydrophobic epoxy resin in the coating composition is no more than 30:70.

15. A substrate at least partially coated with a coating deposited from the solvent-borne coating composition of claim 1.

16. The substrate of claim 15, wherein the substrate is a polyamide substrate.

17. A solvent-borne coating composition comprising:
(a) an amine-amide compound comprising the reaction product of:
(i) a polyamine having substantial aromatic content, and
(ii) a polyfunctional compound comprising an acyl group that forms an amide group moiety by reaction with the polyamine; and
(b) a hydrophobic epoxy resin formed from:
(i) a polyepoxide, and
(ii) a functional-terminated diene-containing polymer.

18. A method for improving the adhesion of a coating layer to a plastic substrate comprising:
(a) applying to at least a portion of the substrate a solvent-borne coating composition comprising:
(1) an amine-amide compound, and
(2) a hydrophobic epoxy resin;
(b) allowing the solvent-borne coating composition to cure to form a primer layer; and
(c) applying a second coating composition over at least a portion of the primer layer to form the coating layer.

19. A polyamide substrate at least partially coated with a coating that adheres to the polyamide substrate and is humidity resistant, wherein the coating is deposited from a solvent-borne coating composition comprising:
(a) an amine-amide compound, and
(b) a hydrophobic epoxy resin.
